(19) United States
(12) Patent Application Publication
(10) Pub. No.: US 2014/0101079 A1
(43) Pub. Date: Apr. 10, 2014

(54) Massively Distributed Problem Solving Agent

(71) Applicant: Steven Vaughn Deal, Yellow Springs, OH (US)

(72) Inventor: Steven Vaughn Deal, Yellow Springs, OH (US)

(21) Appl. No.: 13/649,105

(22) Filed: Oct. 10, 2012

(51) Int. Cl. G06F 15/18

(52) U.S. Cl. 706/12

(57) ABSTRACT

A knowledge processing system that guides massive numbers of human agents and artificial agents to define, explore, and develop solutions for complex, problematic situations, that facilitates a seven-step process that proceeds from instance initiation, problem definition, problem exploration, approach selection, solution selection, to a time-sequenced action plan, and enables agents to subsequently modify process outputs and the action plan; a hybrid facilitation system in which machine and human agents jointly select the content and order of process steps and the system prompts that guide the problem-solving process; and an information-overload mitigation system which reduces the amount of information agents are required to process by means of natural language processing and graphical processing algorithms that characterize agent inputs and background materials, and identify, tag, sequester, and eliminate identical content and direct useful content to agent-defined points of application in the process.

### CROSS-REFERENCE TO RELATED APPLICATIONS

The present application is related to provisional patent application No. 61/546,436 filed October 2011.

### BACKGROUND

Terminology

The term “machine” as used herein refers to a collection of hardware and software elements organized to achieve a common purpose.

The term “agent” as used herein refers to human and machine entities.

The term “internet scale” as used herein refers to the number of agents with a presence on the internet, e.g., thousands, millions, or billions.

The term “massively distributed” as used herein refers to participation across a network that extends up to internet scale enabling ubiquitous access from any location to which the network extends.

The term “facilitation” as used herein refers to the guiding of activities related to problem-solving.

The term “facilitated dialogue” as used herein refers to a method of group learning and decision making involving inter-agent dialogue that is structured by a facilitating agent.

The term “complex problem” as used herein refers to a problematic situation in which there exists two or more interacting dimensions, facets, or domains of expertise such that action taken in one dimension can simultaneously affect another dimension or dimensions positively or negatively, and in which actions must be taken in multiple dimensions for problem resolution and retirement to be achieved.

The term “information item” as used herein refers to an electronic artifact containing data, text, audio, graphics, video, or other symbols. Agent inputs, outputs, products and background materials are examples of information items.

The term “background material” as used herein refers to an information item that provides information regarding the antecedents or factors contributing to a complex problem. Background materials are information items generated outside of the problem-solving process. Examples include research papers, news items, opinion pieces, photographs, or videos.

The term “forum” as used herein refers to an assembly for discussion.

The term “parent forum” as used herein refers to a forum that addresses aspects of a complex problem as a whole.

The term “child forum” as used herein refers to a forum that addresses one dimension of a complex problem.

The term “closure” as used herein refers to the state in which a conclusion or resolution has been achieved.

The terms “information overload” and “data overload” as used herein refer to the condition when the speed or volume at which information is presented to a human or machine agent overwhelms processing capacities. Human agents have cognitive limits to working memory which undermine the ability to understand or make decisions when these limits are exceeded. Machine agents are similarly limited by bandwidth and processor clock speeds.

The term “structured problem solving” as used herein refers to a model of group decision making in which agents interact to take advantage of group knowledge to generate, rank and select ideas. Examples of structured problem solving methods include Interactive Management (also referred to as Structured Design Process), Nominal Group Technique, the Delphi Process, the DesignShop, Visionary Team Planning, and TRIZ. Structured problem solving is a formal decision process that employs questions, answers, and consensus methods, such as negotiation, bargaining, or voting to reach communal decisions.

The term “recognition primed decision making” as used herein refers to a model of unstructured, decision making in which decision makers do not compare options, but begin with a course of action that is feasible based on their past experience. When the decision maker recognizes the situation as an analog to previous experiences, the decision maker selects a course of action based on what has worked in similar situations before. When there is no clear analogy, the decision maker conducts mental simulations, or thought experiments, to test a course of action before implementing it. The decision maker may determine a course of action is feasible or not based on mental simulation outcomes.

The term “point of use” as used herein refers to that place in a problem-solving process at which an information item can be applied for a purpose. Examples of purposes include learning, education, sense making, decision making, calculation, and simulation.

“Requisite variety” as used herein refers to a principle which holds that only variety can address complexity. Requisite variety is satisfied by, for example, a multiplicity of perspectives being applied to a complex problem.

“Requisite parsimony” as used herein refers to a principle which holds that limits to the amounts of information agents can process must be incorporated into decision making processes.

Satisfaction of requisite variety is constrained by principles of requisite parsimony. Large groups are required to address complexity, but become unwieldy to lead. Additionally, the amount of information generated by large groups becomes difficult to process. Information overload and the unintentional exclusion of relevant, and perhaps vital, information can be consequences.

The term “massively distributed problem solving” as used herein refers to collaborative problem solving in which hundreds, thousands, millions or billions of people work together to resolve a complex problem. Collaborative problem solving is a routinely implemented procedure carried out in various forms for a variety of purposes, such as activity coordination or product design. The simplest problems are commonly resolved through informal conversations; the proverbial water-cooler conversation and web forums are examples. More involved problems are routinely handled in small, agenda-guided meetings. As problems increase in complexity, the principle of requisite variety dictates the inclusion of more perspectives with a commensurate increase in the number of participants. Problems of great complexity, such as difficulties with the world economy, benefit from massive participation.

The term “instance” as used herein refers to one application of the MDPSA to a specific complex problem.

Field Of The Invention

The present invention is an approach to massively distributed problem solving. It acts in place of a human facilitator to guide a process of structured and unstructured decision making that incorporates human and machine agents.

More specifically, the invention is directed to knowledge processing systems in which process controls and artificial intelligence manage voluminous contributions from internet-scale agents enabling satisfaction of requisite variety conditions while mitigating information overload.

Description of the Related Art

Face-to-face, facilitated problem solving is constrained to a number of participants that can be managed by a human facilitator or a human facilitator with assistances. Computing means have been introduced to visualize products generated by participants. Algorithms have also been used to reduce the time made comparing alternatives. However, in highly complex problems, the satisfaction of requisite variety conditions, of presenting all stakeholder perspectives and unique points of view is limited by human facilitator capabilities, distance, and cost of convening the necessary group.

The technique of crowd sourcing has been developed to collect and combine vast number of stakeholder perspectives. Massive numbers of participants select their preferences from provided choices or from choices developed by participants. Crowd sourcing fails to allow participants to develop a context-based problem definition. It does not enable participants to bring a problem to closure by means of a participant-developed action plan.

The present invention accomplishes massively distributed problem solving by means of facilitation that is jointly enacted by participating agents and the invention. Problem solving is based on the agent-defined context and the requirements of a complex problem. Agents and the MDPSA collaboratively determine the direction problem solving will take and the options that will be considered. Agents are led to decompose the complex problem allowing experts and novices to address problems at levels commensurate with specialized education and experience. The MDPSA facilitates the synthesis of results by enabling an integration procedure which may be unfamiliar to agents as it receives little attention in curricula and work settings.

The MDPSA incorporates supports to formal, group, problem solving and informal, individual, problem solving. It takes advantage of the experiential insights of individuals while providing structure that aggregates these insights and leads to closure.

The MDPSA extends existing methods for complex problem solving. The architecture removes the constraints to participation that are imposed by processing, cost, and time limitations. The MDPSA enables problem solutions to be adjusted to meet dynamic implementation environments. The MDPSA makes it possible to reuse problem solving products for related or analogous situations and thus to reduce the cost of resolving complex problems.

### BRIEF SUMMARY OF THE INVENTION

One embodiment of the MDPSA can be characterized by:

1) network architecture,

2) hybrid facilitation of a problem solving process,

3) group and individual decision supports,

4) decomposition and synthesis,

5) information overload mitigation,

6) game play and scoring, and

7) reuse of process products.

Network Architecture

Massively distributed problem solving is achieved by means of a network of interacting agents. Examples of networks on which the MDPSA could be implemented include the internet, organizational intranets, local area networks, restricted or classified networks, mobile networks, and satellite networks. A network architecture enables agents with access to the network to participate in a problem solving activity. As a result, the number of collaborating agents can be as great as the number of agents connected to the network.

Through a network, ubiquitous access to a problem solving instance is achieved at any time and from any location that has connectivity with a network on which the MDPSA has been implemented. Network protocols enable agents to access and to be accessed by the MDPSA for the purpose of collecting agent inputs and information items, processing information, generating outputs, and referencing and storing information items.

Agent Inputs and Outputs

Agent inputs consist of human and machine contributions of information items to the problem solving activity. In one embodiment, information provided by the MDPSA takes the form of questions; inputs from participating agents include answers to questions, contributions to discussions, photographs, data graphics, video representations, and audio representations. For example, the MDPSA could ask, “What expertise is needed to alleviate this situation?” Both human and machine agents would subsequently respond with their ideas in some cases supported by authoritative data sources. In one embodiment, the MDPSA executes a search of the network for information of relevance to the problem solving instance. Search findings are treated as agent inputs. They are included by reference or are archived within the MDPSA.

Outputs are generated to support decision making and sense making They constrain the direction in which the problem-solving activity proceeds and they capture an action plan for resolving the situation. Process outputs are created by agent selections in the course of defining, exploring, resolving and envisioning the circumstances a complex problem. In one embodiment, process outputs take the form of lists of alternative ideas, or graphic displays. For example, a means-end hierarchy graphic could be generated to depict the causes of a problem and the relationship of aggravating problems that proceed there from. In another embodiment, process outputs take the form of stories that are depicted via text or audio verbal channels or by static or graphic animations. For example, an agent could supply a video animation that captures the result of a mental simulation. In another embodiment, process outputs take the form of a time-phased set of activities and tasks, e.g., a Gantt Chart.

An aim of structured problem solving is to produce a communal understanding of a problematic situation. This aim is achieved through the exchange, access and retrieval of information contributions to the problem solving instance. In one embodiment, an archive of information items is included to extend agent memory capacities. In one embodiment a summary of information contributions is continuously updated and archived to support sense making and to mitigate information overload. Information items are stored for retrieval and reference over the network.

Information items can be supplied to the archive in several ways. In one embodiment, agents supply materials by means of electronic transfer or upload. In one embodiment, agent inputs and outputs are placed in the archive by the MDPSA in the course of recording the contents of a dialogue or generating problem solving products. In one embodiment, background materials are discovered and supplied by MDPSA computational processing methods that drive search and retrieve capabilities.

Inputs can be stored either in a central location, in multiple locations, or by reference. Information that is frequently updated by authoritative sources, such as population data, national debt figures, or salary information is stored by reference to ensure the most recent updates are available to support problem solving activities. In one embodiment, virtual references to remotely stored information items are included in the archive. For example, remote information recorded as a web site or stored in a networked database could be accessed by agents through file transfer protocols, hyperlinks or other access means. References are generated by agents and by the MDPSA. Agents are prompted to supply hyperlinks or other information pertaining to access of remote or networked information when adding a remotely stored item to the archive. The MDPSA provides references for information discovered and supplied by its computational processing methods. In one embodiment, web locations of remote items are graphically displayed in a network representation that depicts not only access references, but also the relationships between information items.

Agents use metadata as a tool for identifying and retrieving information. Agent needs for metadata vary by the criteria they use to select information item. For example, a machine agent may seek to access a stored piece of information by data type or data size. Human agents may employ semantics or contextual cues as aids to associative retrieval. In one embodiment, human and machine participants and the MDPSA apply metadata to information articles for the purpose of retrieval. Examples of metadata include information-item creation name, keywords, data type, author name, thumbnail representations, creation date, agent name, contribution date and time, scoring, and number of times the information article was accessed. In one embodiment, agents assign a score to an information item to indicate its usefulness or lack of utility in supporting a problem solving activity. For example, a five-point Likert scale could be used to score an item, or a polar assessment of ‘useful’ or ‘not useful’ could be assigned.

Hybrid Facilitation of a Problem Solving Process

An MDPSA instance enacts a problem solving and planning process that is implemented in accordance with facilitated dialogue methods. The MDPSA acts as the guiding agent of one or more dialogue, polling, comparison, envisioning or other problem-solving process. In one embodiment, the process begins with a description of the problematic situation that is to be addressed and with a description of the context and constraints which will delimit process execution. The process concludes with a time-phased plan for the implementation of a selected solution. The time-phased plan is one of several process objectives which are achieved by means of a stepwise progression. The process can be terminated with value after the achievement of any one or all of the objectives.

Existing methods of group problem solving are guided by human facilitation or machine facilitation. Purely human facilitation is subject to parsimony constraints; after a certain number, degradation to a human facilitator's effectiveness correlates with an increase in the number of participants. Purely machine facilitation inflexibly employs algorithms which adapt poorly to specific situations; machine facilitation constrains decision making to pre-selected processes and solutions, and may unnecessarily constraint the solution space. Hybrid facilitation overcomes the limitations of exclusively human or exclusively machine facilitation by enabling participants to modify process execution, to submit context-relevant options, and to select from both pre-programmed and participant-generated ideas. Hybrid facilitation provides guidance that is structured yet flexible. Human agents creatively guide process execution within algorithmic limitations that assure the problem solving activity will achieve closure. In hybrid facilitation human inputs interact with programmed facilitation algorithms to tailor the problem-solving experience to meet the context and needs of the problematic situation or the capabilities and capacities of participating agents.

In one embodiment, the MDPSA facilitates the problem solving process using agent-selected and agent-generated questions. Agents select from MDPSA-provided question lists that guide idea generation, comparison, selection, and dialogue. Agents also generate questions specific to the needs of the complex problem. The MDPSA records and stores agent-generated questions and adds these to the selectable question lists that are presented to agents in subsequent instances. Agents vote to select questions that the MDPSA will use to facilitate subsequent process activities.

In one embodiment, the MDPSA reviews agent-generated questions. It provides advice on their effectiveness and guidance on how agent-generated questions can be improved. For example, in order to facilitate identification of the problems of which the problematic situation is comprised, the MDPSA could provide a list comprised of the following two questions: “What problems do you see that lie ahead in this problematic situation?” “What problems do you anticipate in striving to resolve this problematic situation?” An agent could submit the alternative question, “What is the nature of the situation?” The MDPSA would analyze the agent-provided question to determine if it supports process objectives. If the MDPSA determines the question does not, it would recommend an alternative such as, “What are the characteristics of the situation?” The agent that provided the question could elect to accept or reject the recommendation. Participants would vote on the integrated list of MDPSA-provided and agent-provided questions to select the question or questions of which subsequent process activities would be comprised. The MDPSA would continue process facilitation using the questions that received the greatest number of votes.

Group and Individual Decision Supports

Decision making is implemented in accordance with social science and cognitive models. Requisite variety dictates the need for individual perspectives to establish relevance and to make contextual sense of a body of information. Group perspectives are required to establish relationships and dependencies.

Groups of agents explore collective and contrasting perspectives and achieve consensus in accordance with facilitated dialogue methods. In one embodiment, a cycle of question, answer, clarification, selection, structuring and refinement is at the core of the process. Agents respond to questions and then engage in dialogue to clarify responses and achieve a common understanding of each response. Polling is used to select those answers that are perceived to have the greatest impact on the complex problem. Pairwise comparison is used to structure means-end relationships among clarified ideas. Agents review graphic depictions of relationships and engage in dialogues to suggest modifications that refine outputs as represented in the graphic representations.

Individual decision making is implemented in accordance with the recognition primed decision model as described by Klein. The recognition primed decision model holds that people rarely weigh alternatives and compare them in terms of ranking criteria. Individuals make decisions based on situational context, remembered knowledge, and experience. In one embodiment, agents are asked to think of and seek out analogous situations. If perfect analogs do not exist, the MDPSA guides agents to conduct mental simulations. As a result, idea generation and decision making are facilitated in a way that matches the processing agents naturally use to address problems.

In one embodiment, the MDPSA requests agents to consider the avenues (legal, technology, information approaches) through which a problem could be addressed. Individual decision making is implemented by asking agents to recall the avenues they have found to be effective in similar situations, and to tell the story of how the implementation worked. Group decision making is implemented by polling agents for a preferred avenue based on stories of past successes. In one embodiment, individual decision making is implemented by prompting agents to imagine solutions implemented through an avenue, and to describe and submit their mental simulations. Group decision making is implemented by facilitating dialogues about each simulation, and by polling agents to select preferred avenue based on perceived story relevance to the extant problematic situation and on discussion content.

For example, the MDPSA could be applied to the problematic situation surrounding industrial pollution. In one embodiment, the MDPSA presents a list of avenues such as technology, investment, re-engineering, analysis, experiment, marketing, organizational change, statutory change, regulatory change, education, and quality improvements as approaches to addressing the pollution problem. Agents would be guided to generate and submit stories describing how the listed avenues could be applied to problematic situation. Agents could submit a research paper obtained via an on-line publisher, provide a text or audio version of the story, present a cartoon storyboard, or provide a computer simulation. For example, one agent could describe a technology approach that places emphasis on implementing an air filter. Another agent could provide an article that depicts the historic results of statutory change. Each submission would be considered by the group of participating agents through facilitated discussion. A preferred avenue would be selected by vote.

Structured processes used for group decision making aim at optimal solutions based on deliberative comparisons, but they depend upon the creativity, insight, and innovation of individuals. As a result, individual decision making can be thought of as a component of group decision making The MDPSA facilitates a process that combines the satisfying approach of individuals with the optimizing approach of formal, group, decision making

Decomposition and Synthesis

Whole-part decomposition and synthesis are implemented in accordance with the principles of systems engineering. Hierarchical decomposition of a complex problem exposes specific dimensions of a problematic situation to agent scrutiny. Synthesis integrates intra-dimensional discoveries so they can be holistically applied to problem and solution definition.

The MDPSA is rooted in the premise that human agents more readily apply expertise to parts rather than to the whole of complex problems; this perspective is exemplified by curricula and employment roles that emphasize specialization over generalization. Machine agents similarly store data storage by subject and not by holistic context. Complex problem decomposition enables agents to contribute to a problem solving activity at a granularity that aligns with practice.

In one embodiment, the MDPSA decomposition functions guide participants to divide a complex problem into constituent dimensions. Constituent dimensions are considered in child forums in which agents engage in dialogues to identify and define problems and solutions that contribute to the problematic situation. In one embodiment, an agent aligns expertise, interests, and specialization with a constituent dimension by self-selection. For example, an economic problem could be decomposed into the following dimensions: manufacturing; sources of supply; capital sources; and consumer issues. An industrialist might choose to participate in the child form addressing manufacturing. A marketing executive might chose to participate in both the manufacturing and consumer issues forums. In one embodiment, the MDPSA and agents work collaboratively to align agent expertise and interest with the influential dimensions. For example, agents could be required to submit a history of their education and work experience as part of registration. The MDPSA would autonomously assign agents to child forums that align with their expertise based on their submitted history. Agents would be given the opportunity to select additional child forums in which they wish to participate or to opt out of child forums to which they were assigned.

The MDPSA is rooted in the premise that the emphasis higher education and work roles place on specialization leaves people ill-prepared to synthesize solutions to complex problems. As a result, human agents are more likely consider only the influences their area of expertise exerts on other dimensions of a complex problem. Similarly, machine-agent data structures are designed to relate elements contained in a data structure, but fall short of creating meaning from stored data integrated across information domains.

In one embodiment, the MDPSA synthesis functions guide agents to integrate issues discovered in the constituent dimensions of a problematic situation, so they can be regarded in the context of the complex problem in its entirety. Child forum outputs are integrated in a parent forum. In the parent forum, relationships between child-forum, means-end findings are explored. In one embodiment, the MDPSA generates a draft, integrated structure, presented in graphical format, which relates dependencies defined in one child forum to those of the other child forums in the instance. Agents are guided through a process of clarification and polling to refine the integrated structure.

For example, the MDPSA decomposition and synthesis functionality could be used to implement a multidisciplinary curriculum whose aims are to integrate subjects such as mathematics, science, and social studies. The complex problem, “What are the impacts of educational technology on student achievement?” would be posed to students. Students, teachers and parents would be prompted to discuss the topic from the perspectives of mathematics, science and social studies in child forums. The mathematics class would study and discuss statistical methods, review experimental data, and develop mathematical models of technological impacts on education. The science class would look at the technologies that have been tested, survey emergent technologies, and talk about the pros and cons of each. The social studies class could list educational settings, and discuss the ways educational technology could be implemented in each. The MDPSA would facilitate information gathering, dialogues, selection of driving influences, and the establishment of relationships between influences. Findings from the mathematics, science and social studies classes, captured in child forums, would be integrated in a parent forum. Participants from all the child forms would be guided by MDPSA to exercise critical thinking to understand the causal relationships between the integrated information, and to answer the topic question regarding educational technology.

Information Overload Mitigation

Group problem solving on the internet scale could generate information of a magnitude that would cause information overload. In the present invention, computational processing methods are applied to reduce the processing strains induced by large volumes of information.

The MDPSA implements methods of natural language processing and graphics processing to reduce the cognitive and processing load on agents. In one embodiment, natural language and graphics processing are employed to extract attributes from individual agent inputs. For example, an agent might submit an audio recording of a verbal response to a question posed by the MDPSA. Computational linguistics methods would convert the audio response to text, and extract content attributes, such as meaning, intent, context, or emotional content. In one embodiment, extracted attributes are used to perform pairwise comparisons of agent inputs, and to identify and cull from a dialogue those that are substantially or statistically identical. For example, a graphics processing algorithm would compare two photos and determine that the two photos are the same with a high degree of probability. The existence of a duplicate photo would be indicated to agents, but only one photo would be displayed. In one embodiment, natural language and graphics processing methods are used to summarize entire dialogues. Summaries enable agents to review an abstracted version of a dialogue, and would thus mitigate information overload. In one embodiment, the content of an information-item archive is used to train natural language and graphical processing methods. Training can improve method performance, and helps with identifying attributes relevant to the complex problem.

A means of satisfying requisite parsimony is to reduce the need for agents to search through dialogues and archives to identify relevant information. This can be accomplished by automatically identifying salient information and directing it to a point of use. In one embodiment, computational methods analyze the content of instance dialogues and extract attributes such as key words, proper names, phases, activities, shapes, or symbols from dialogue content. Attributes are used by agents to identify content that is relevant to a particular dialogue from across the instance or from across the network, and make the identified information available to agents in that particular dialogue.

In one embodiment, attributes identified as relevant to a dialogue are selected by agents from the list of extracted attributes. For example, a parent instance could address a complex problem that addresses the sustainability of a city. Dimensions of this complex might include topics such as energy generation, environmental issues, employment, and economics. Each dimension would be discussed in a separate child forum. Computational methods would sift agent inputs and information items, and generate a list of attributes related to the problematic situation as a whole or to one of its constituent dimensions. An agent engaged in the dialogue about energy generation could select attributes such as “capacity”, “kilowatt hours”, and “rates”, from the MDPSA-generated list. The MDPSA would then sift subsequent inputs to all dialogues to identify agent contributions that make reference to “capacity”, “kilowatt hours”, and “rates”. These inputs would be identified as containing information relevant to the energy generation dialogue. The MDPSA would insert the relevant contribution into the energy generation dialogue.

In one embodiment, attributes relevant to a dialogue are autonomously selected by MDPSA computational methods. Without intervention from human agents, the MDPSA sifts the contributions to a dialogue and identifies content attributes. The MDPSA subsequently sifts the contents of other dialogues, identifies and selects contributions containing the identified attributes, and inserts the salient contribution at the point of use. For example, the MDPSA would autonomously identify “capacity”, “kilowatt hours”, and “rates” as terms of interest in an energy generation dialogue. Computational methods would sift other dialogues for information that would be relevant to the energy generation dialogue, and would autonomously make that information available to participants of the energy generation dialogue.

In one embodiment, the MDPSA computational methods autonomously sift dialogue content, extract content attributes, and execute a search of the network to identify salient information from across the network. The MDPSA makes identified, relevant information available to dialogue participants by insertion of by reference into the dialogue stream or by incorporation of relevant information into a data archive.

Through autonomous, supervisory, and manual functions, the MDPSA lightens agent processing load in order to mitigate information overload. As a result, agents on an internet scale are able to collaboratively bring diverse perspectives and information together to develop a joint understanding of a complex problem.

Game Play and Scoring

The MDPSA implements theory-based approaches to motivating human agent achievement and sustained participation. The intensity of structured problem solving can be discouraging to participants. Dispirited participants perform poorly. It is common practice for facilitators of face-to-face problem-solving activities to use treats or rewards to motivate participants. Motivation can be extrinsic, intrinsic, physiological, and achievement oriented. It can be positive or negatively achieved. Power, achievement, progress, growth, affiliation, stimulation, reward, control, goals, investment, opponents, happiness, discomfort, and gambles are attributes of theoretical models of motivation. The influence these attributes exert varies from person to person. People who are motivated are likely to surmount the challenges and stresses that complex problem solving entails.

Agents receive intrinsic reward from the perception of achievement and progress toward a goal. In one embodiment, the MDPSA implements problem solving as an iterative, stepwise process. Each step incorporates unique goals that are represented by products. Agents can experience satisfaction from the achievement of step goals. Agents can perceive progress from the generation of process products that consecutively deepen understanding and build toward a resolution of the problematic situation. For example, in one step, agents identify the challenges that will need to be addressed within one dimension of a complex problem and the means-end relationships between the challenges. In a subsequent step, agents determine actions that can be taken to address the previously identified challenges and the means-end relationships between the actions. Agents perceive this advancement toward a goal as a progression, and are motivated to continue to a resolution. In one particular embodiment, the steps of the problem solving process are presented as game levels.

The MDPSA takes advantage of the polarity in motivation to encourage positive practices that enhance collaborative problem solving and to discourage negative practices that are detrimental to outcomes. Extrinsic rewards can be based on the agent contributions and observable behaviors. Agent performance can be scored in the virtual world in such a way that agent reputations in the real world are enhanced. Enhanced reputations can translate into real-world rewards. In one embodiment, a scoring algorithm is used to assess agent contributions. The algorithm incorporates quantitative information such as number and frequency of contributions, number of consecutive contributions, and first contributions to a dialogue. For example, high numbers of contributions that are frequently provided is indicative of engagement; these contribute to higher scores. A high number of consecutive contributions are indicative of dominance behavior which contributes to a lower score. A high number of individual responses to the contributions of others is indicative of collaborative behavior that contributes to a higher score. The scoring algorithm also incorporates qualitative information such as obscurity of expression as evidenced, for example, by overuse of acronyms. In one embodiment, linguistic and graphical analyses evaluate individual contributions to determine if detrimental behaviors, such as directive, authoritative, disrespectful, impatient, insulting, or profane practices are evidenced; these contribute to a lower score. Linguistic and graphical analyses also assess individual contributions for common argument errors and fallacies such as appeals to ignorance or equivocation; these contribute to a lower score.

In one particular embodiment, agents receive three scores. The first score is based on their performance in a single MDPSA instance. This score drives players to excel in the extant instance. A second score is based on performance over all MDPSA instances in which an agent has participated. This score is an indicator of general problem solving skill. A third score represents an agent's expertise in a particular discipline or subject area. The third score is calculated by examining an agent's contribution in a specific expertise area, such as power generation or education, over all instances in which the agent provided expertise in that discipline. Evidence of contribution influence is also included in the expertise calculation. In one embodiment, influence is determined by natural language processing or graphical analyses that assess whether an agent's contribution served as an organizing principle around which other contributions were arranged. Expertise can also be recognized by other participants as a breakthrough. In one embodiment, peer assessments contribute positively and negatively to the expertise score.

Scores can translate into tangible, extrinsic rewards in the real world. For example, an employer could review MDPSA scores and choose to hire an agent to participate in an MDPSA instance. Employers could select agents based on the aforementioned lifetime score which is representative of an agent's effectiveness in solving complex problems. In one embodiment, expertise scores are used as the basis for a virtual employment process. Hiring entities specify a candidate's qualifications based on their MDPSA scoring. Alternately, agents use MDPSA scores to seek out job opportunities through the internet. The agent's MDPSA scores provide evidence of competency that is used by potential employers as an evaluation criterion.

Reuse of Process Products

In many circumstances, reuse of the products of a problem solving activity could be advantageous and cost-effective. For example, during the implementation of an action plan, contextual changes to the problematic situation commonly take place. Updates to the plan are required. In other circumstances, two problematic situations could have dimensions that are common to both. For example, immigration reform in the State of Arizona would be expected to have many of the same dimensions as immigration reform in the State of Texas. Additionally, problematic situations are often explicitly or analogously similar to other situations. An example of this type of similarity would occur in two exclusive problematic situations involving mass transportation. The problems and solutions associated with an inter-urban railway system would be expected to have analogies or even direct application to those associated with a commuter rail system.

In one embodiment, the MDPSA implements an archive that stores, in summary and complete form, the dialogues, background materials, attribute lists, participants, participant scores, and products of an MDPSA instance. The archive includes agent-generated and MDPSA-generated metadata that enables agents to identify and access materials from historic instances that are relevant to a contemporary instance. For example, an entire instance can be cloned for the purpose of modifying products that addressed a similar problematic situation. Additionally, agents can select a single dialogue for insertion into another instance. Agents could conceivably create a new instance by combining select dialogues of prior instances. Archived participant scores can be used as a filter for inviting effective participants to join a new or re-initiated instance.

### BRIEF DESCRIPTION OF SEVERAL VIEWS OF THE DRAWING

The detailed description of the present invention is best understood when read in conjunction with the FIGURES below:

FIG. 1 a schematic diagram of the massively distributed processing system agent.

FIG. 2 is a step-by-step diagram of the MDPSA problem solving progression.

FIG. 3 is a diagram of the activities of which the progression steps are comprised. The progress is depicted at the top moving from left to right. The activities are shown from top to bottom below each progress step.

FIG. 4 is a schematic diagram of the MDPSA facilitator functions in relationship to the dialogue entry information items. Features that mitigate information overload are depicted.

FIG. 5 is a step-by-step diagram of the process facilitated by MDPSA to generate ideas.

FIG. 6 is a step-by-step diagram of the process facilitated by MDPSA to clarify ideas and mitigate information overload.

FIG. 7 is a step-by-step diagram of the process facilitated by MDPSA to select ideas from those generated by agents.

FIG. 8 is a step-by-step diagram of the process facilitated by MDPSA to structure ideas selected by agents.

FIG. 9 is a schematic diagram of the decompositional relationship between a parent dialogue and child forums. Synthesis functions reverse the arrows so outputs flow from the child forums to the parents.

### DETAILED DESCRIPTION

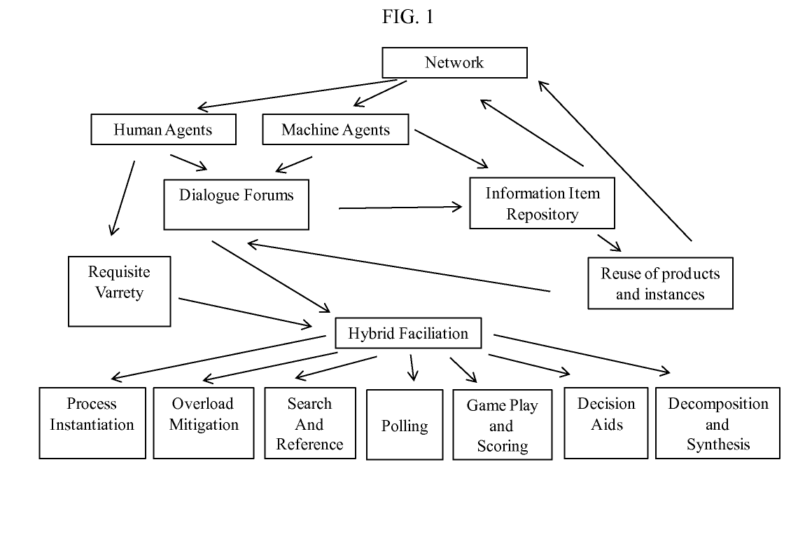

In one embodiment, the MDPSA is a machine agent that is implemented on a network to facilitate a massively distributed problem-solving process the elements of which are depicted in FIG. 1. The machine agent enables human and machine agents to engage in dialogue forums there by satisfying requisite variety criteria. The machine agent enables human and machine agent contributions to an information item repository whose products can be used in whole or in part. The machine agent implements hybrid facilitation that incorporates human and machine inputs along with MDPSA algorithms in process management.

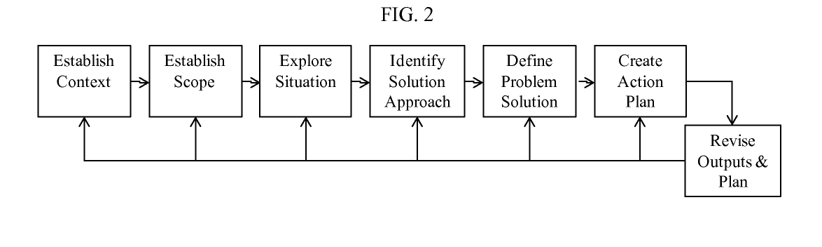

In one particular embodiment of the invention, problem solving progresses through the six steps shown in FIG. 2 that result in an action plan. A seventh step is included for adjusting the products of the six steps or for modifying the action plan. While it is advantageous to approach problem-solving in these steps sequentially, the invention is flexible. Problem solving can involve overlapping steps and certain steps may need to be repeated or readdressed as part of other steps. For example, the progression from establishing the scope of a problematic situation to exploration of the situation to generation of a resolution plan would follow developments as they are exposed in the literature. However, learning that occurs during the solution-generation step may reveal new dimensions of the problematic situation that need to be explored. It would thus be advantageous to revisit earlier steps. Each step has specific products which agents will employ in subsequent steps. Distinct dialogue elements provide opportunities for collaborative learning that help the group to devise, evaluate, and compare solutions, and to develop an action plan to address the problematic situation. Facilitation serves the needs of the participating agents and eases progress toward common goals.

In one embodiment, the first step has as its objective a description of the context of the problematic situation. The second step objective is to determine the scope or extent of the problematic situation. The third step objective is to identify the problems of which the problematic situation is comprised. The fourth step objective is to select approaches to the complex problem. The fifth step objective is to generate solutions for the identified problems. The sixth step objective is to generate an action plan for a solution. The seventh step objective is to modify the action plan. Agents contribute to problem solving by answering questions, discussing answers, voting to select from agent-generated options, and determining means-end relationships between options. Progress is directed by a combination of MDPSA and agent facilitation. In one particular embodiment, agents are guided to contribute verbal descriptions or graphical representations of mental simulations that agents use to test ideas and their consequences.

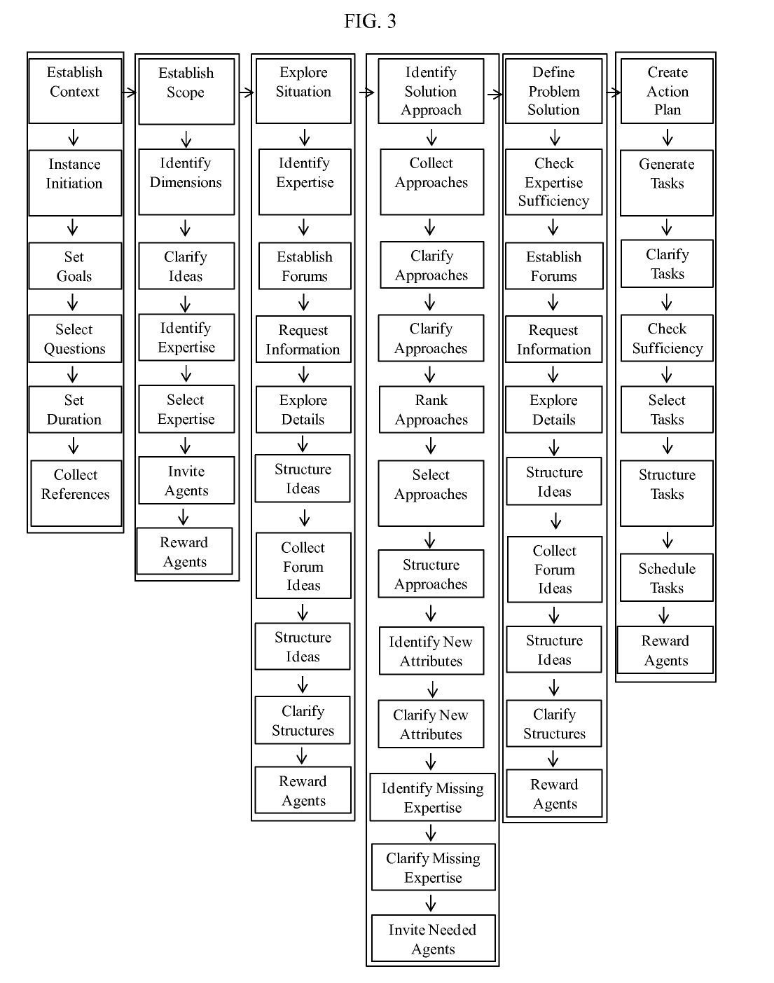

The seven steps of one embodiment of the invention are described in outline form below. Details of steps one through six of this embodiment are provided in FIG. 3. It will be noted that in this embodiment of the invention, the first step objectives are a description of the circumstances surrounding a complex problem and a description of conditions that constrain execution of the problem solving process. The second step objectives are to decompose the problematic situation into dimensions, facets, or domains of which the complex problem is comprised, and to identify the knowledge or expertise needed to investigate the complex problem. The third step objectives are to identify problems that must be addressed in each of the dimensions, to build a model of means-end relationships between the problems in one dimension, and to relate the problems identified in one dimension to those of all the other dimensions. The fourth step objectives are to select approaches by which the complex problem will be addressed, and to identify interdependencies between selected approaches. The fifth step objectives are to generate solutions for the identified problems, to build a model of the means-end relationships between the solutions to problems in one dimension, and to relate the solutions from one dimension with those of all the other dimensions. The sixth step objective is to generate a time-phased, action plan for enacting a solution. The seventh step objectives are to revise products and decisions made in previous steps, and to modify the time-phased action plan. The following outline describes steps embodiments of the invention support.

Initiating an Instance (Step 1): Establish Context
Setup: Characterize the setting of the problematic situation
End: Context of situation, context of instance, step 2 trigger questions, and participants

Objectives:
Initiate the instance and describe the context of the situation
   Describe the setting of the problematic situation
      Include who can resolve
      Identify locations affected
   Describe solution-constraining events and times
   Describe the importance of the complex problem
      Include who is affected
   Provide background materials
Set goals and describe the context of the problem-solving process
   Define success criteria
   Describe benefits sought
   Include beneficiaries of the instance
   Include stakeholders in the instance
   Develop a schedule and milestones
   Identify initial participants
   Provide constraints on who is allowed to participate
Select or create trigger questions
   Review questions provided
   Write situation-specific questions
   Choose questions
Determine time durations for responses to questions
Assemble participants

Send invitations
Send context description
Offer incentives

Identify dimensions of complex problem (Step 2): Establish Scope
Setup: Present trigger question
End: Dimensions of the complex problem and needed expertise

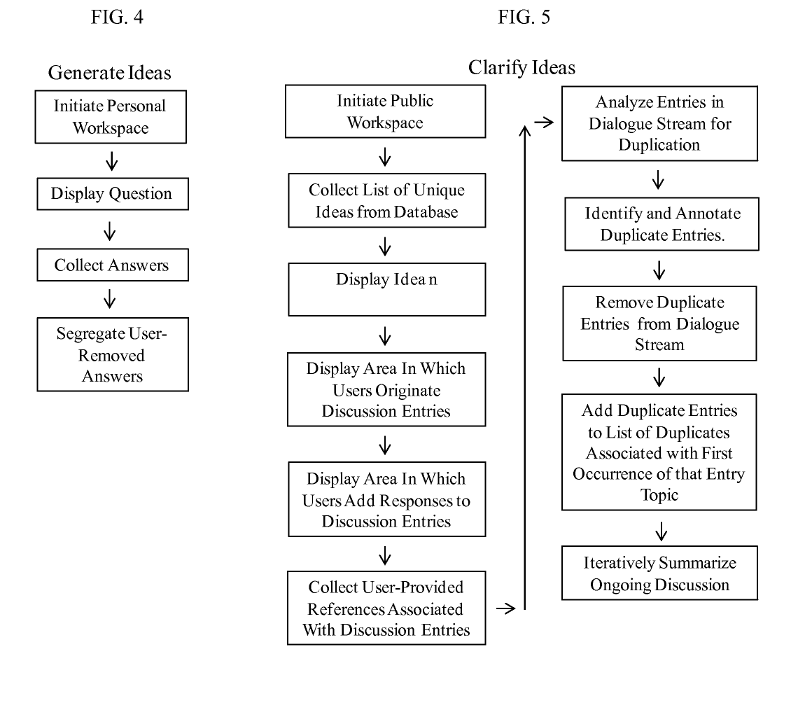

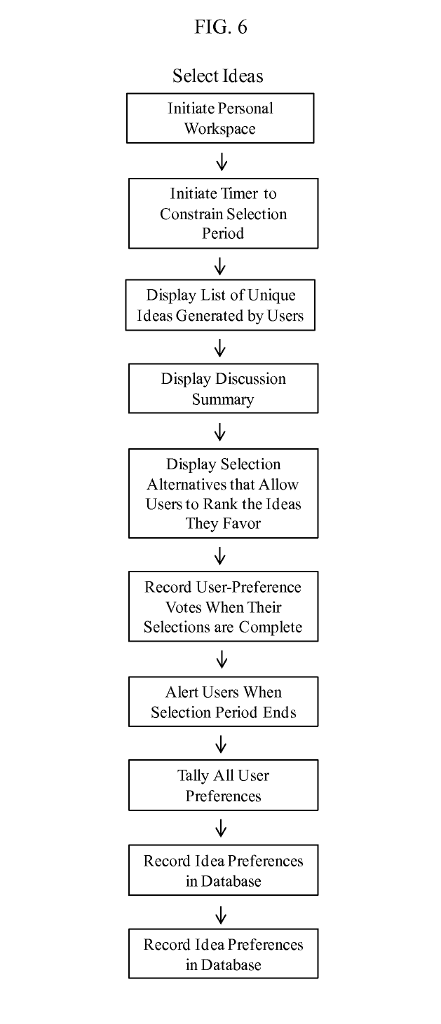

Objectives:
Identify dimensions of the complex problem (See FIG. 4)
   Contribute background materials
   Initiate personal workspace
   Review trigger question
   Answer trigger question
   Eliminate duplicate answers
   Clarify answers in dialogue (See FIG. 5)
   Summarize dialogue
   Vote to select subset of answers to take forward (See FIG. 6)
Identify additional expertise required
   Review trigger question
   Answer trigger question
   Eliminate duplicate answers
   Clarify answers in dialogue
   Summarize dialogue
   Vote to select subset of answers to take forward
Obtain required additional expertise
   Send invitations
   Send context description
   Offer incentives
Reward agents
   Calculate scores
   Post scores

Identify problems within dimensions (Step 3): Explore Situation
Setup: Decompose instance into child forums for each dimension identified in step 2
End: Problems and means-end relationships between them

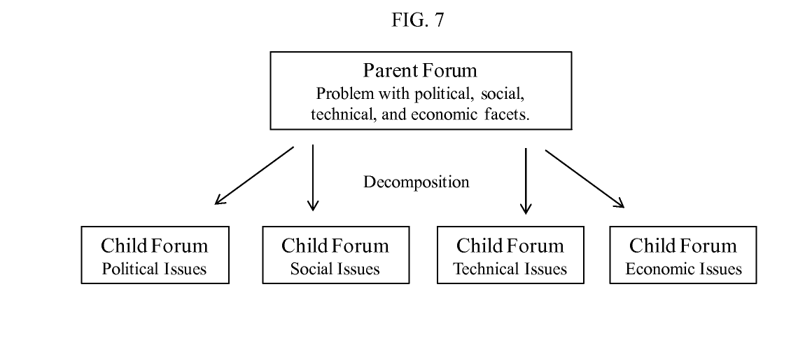

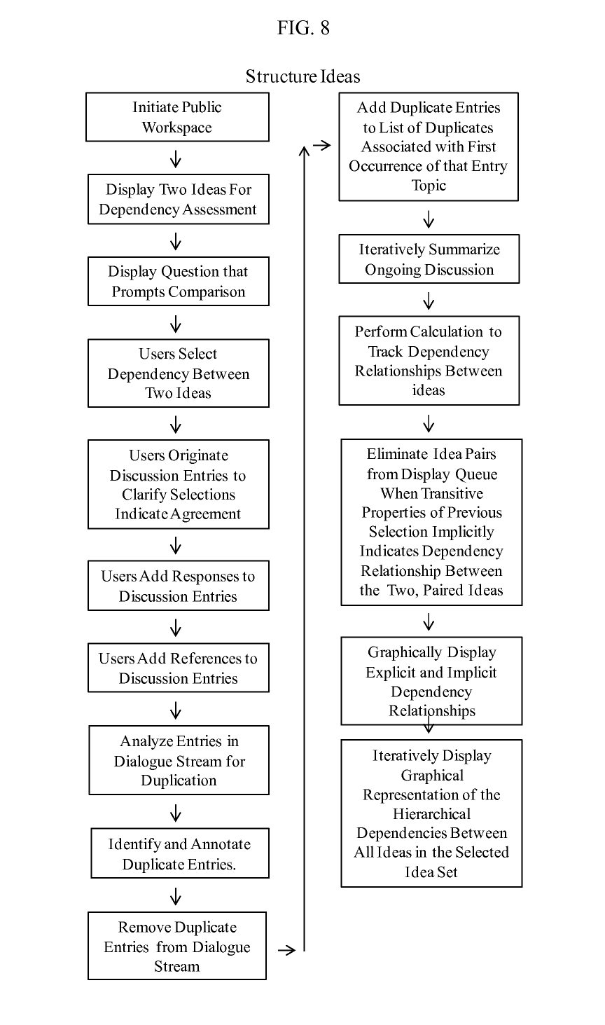

Objectives:
Distribute agents into child forums (See FIG. 7)
   Assignment of agents using self-identified expertise and interests
   Agent self-selection of or de-selection from forum participation
Manually define salient information identification criteria
   Extract content attributes from information items
   List content attributes
   Review list of content attributes
   Select point of use for salient information delivery in dialogue structure
   Select content attributes from list
   Create new identifiers for salient information selection
Identify problems in child forums (for each forum)
   Conduct mental simulations
   Answer trigger question
   Generate a list of problems
   Cull duplicate answers
Request information
   Select keywords that system will search
   Add terms of interest
   Set up searches of forums
Explore details in child forums
   Generate ideas
   Clarify meaning of answers
   Review answers one at a time
   Generate common understanding of answer in dialogue
   Cull duplicate entries from clarifying dialogue inputs
   Provide background material to substantiate claims in dialogue
   Transport information identified by content attributes to point of use
   Vote to select subset of answers to take forward
   Summarize dialogue
   Archive dialogue
Structure relationships between subset problems in child forums (See FIG. 8)
   Select child forum
   Conduct pairwise comparisons of problems
      Answer dependency question comparing two problems
   Conduct mental simulations
   Dialogue about answer rationale
   Provide background material to support rationale
   Cull duplicates entries from dialogue inputs
   Summarize dialogue
   Archive dialogue and summary
   Compare remaining problems
   Create graphical representation of problem relationships
Structure relationships between all problems at parent level
   Collect problems from all child forums into parent forum
   Establish draft relationships between child-forum problems
   Conduct mental simulations
   Revise draft relationships
   Answer dependency question comparing two problems
   Dialogue about answer rationale
   Provide background material to support rationale
   Cull duplicates entries from dialogue
   Summarize dialogue
   Archive dialogue and summary
   Compare remaining problems
   Create graphical representation of problem relationships
Clarify and refine relationships
   Review graphical representation of relationships
   Edit the display
   Annotate the display
   Archive the display
Reward agents
   Calculate scores
   Post scores

Select tools to be used (Step 4): Identify Solution Approach
Setup: Review problems and means-end relationships between them
End: Approaches and dependency relationships between them, additional dimensions of the complex problem and additional expertise required

Objectives:
Complete a list of approaches to the complex problem
   Display draft list of MDPSA-selected, ranked approaches
   Review list
   Recall analogs with similar, previous situations
   Provide suggestions for additional approaches
Clarify meaning of approaches
   Review approach
   Generate common understanding of approach in dialogue
   Conduct mental simulations
   Collaboratively review simulation results
   Cull duplicate entries from dialogues
Rank approaches
   Vote to select subset of approaches
   Summarize dialogue
   Archive dialogue
Identify relationships between subset of approaches
   Answer dependency question comparing two approaches
   Dialogue about answer rationale
   Provide background material to support rationale
   Cull duplicates entries from dialogue
   Summarize dialogue
   Archive dialogue and summary
   Compare remaining approaches
   Create graphical representation of problem relationships
Display relationships
   Review graphical representation of relationships
   Edit the display
   Annotate the display
   Archive the display
Identify additional dimensions of the complex problem
   Answer trigger questions
   Eliminate duplicate answers
   Clarify answers in dialogue
   Summarize dialogue
   Archive dialogue
Identify additional expertise required
   Answer trigger questions
   Eliminate duplicate answers
   Clarify answers in dialogue
   Summarize dialogue
   Archive dialogue
Obtain required additional expertise
   Send invitations
   Send context description
   Offer incentives
Reward agents
   Calculate scores
   Post scores

Identify solutions to problems (Step 5): Define Problem Solution
Setup: Decompose instance into child forums for each dimension of the complex problem
End: Solutions and means-end relationships between them

Objectives:
Check that requisite variety is satisfied by participating agents
   Assess participation status of newly invited agents
Distribute agents into child forums
   Assignment of agents using self-identified expertise and interests
   Agent self-selection of or de-selection from forum participation
Manually define salient information identification criteria
Extract content attributes from information items
   List content attributes
   Review list of content attributes
   Select point of use for salient information delivery
   Select content attributes from list
   Create new identifiers for salient information selection
Identify solutions in child forums (for each forum)
   Conduct mental simulations
   Answer trigger question
   Generate a list of solutions
   Cull duplicate answers
Clarify meaning of answers
   Review answers one at a time
   Generate common understanding of answer in dialogue
   Cull duplicate entries from clarifying dialogue inputs
   Provide background material to substantiate claims in dialogue
   Transport information identified by content attributes to point of use
   Vote to select subset of answers to take forward
   Summarize dialogue
   Archive dialogue
Identify relationships between child solutions (for each child forum)
   Select child forum
   Conduct pairwise comparisons of solutions
      Answer dependency question comparing two solutions
   Conduct mental simulations
   Dialogue about answer rationale
   Provide background material to support rationale
   Cull duplicates entries from dialogue inputs
   Summarize dialogue
   Archive dialogue and summary
   Compare remaining solutions
   Create graphical representation of solution relationships
Identify relationships between all solutions at parent level
   Collect solutions from all child forums into parent forum
   Establish draft relationships between child-forum solutions
   Conduct mental simulations
   Revise draft relationships
   Answer dependency question comparing two solutions
   Dialogue about answer rationale
   Provide background material to support rationale
   Cull duplicates entries from dialogue
   Summarize dialogue
   Archive dialogue and summary
   Compare remaining solutions
   Create graphical representation of solution relationships
Display relationships
   Review graphical representation of relationships
   Edit the display
   Annotate the display
   Archive the display
Clarify and refine relationships
   Review graphical representation of relationships
   Edit the display
   Annotate the display
   Archive the display
Reward agents
   Calculate scores
   Post scores

Create a time-phased action plan (Step 6): Create Action Plan
Setup: Display graphical representations of problem relationships, approach relationships, and solution relationships
End: Time-phased schedule of tasks

Objectives:
Identify tasks
   Answer trigger question
   Eliminate duplicate answers
   Clarify answers in dialogue
   Check sufficiency of generated tasks
   Summarize dialogue
   Vote to select subset of answers to take forward
Identify relationships between subset of tasks
   Conduct pairwise comparisons of tasks
      Answer dependency question comparing two tasks
   Conduct mental simulations
   Dialogue about answer rationale
   Provide background material to support rationale
   Cull duplicate entries from dialogue
   Summarize dialogue
   Archive dialogue and summary
   Compare remaining tasks
   Create graphical representation of task relationships
Develop schedule
   Identify task start date
   Determine task duration
   Review each task in dialogue
   Provide background material to support rationale
   Cull duplicates entries from dialogue
   Summarize dialogue
   Archive dialogue and summary
   Review remaining tasks
   Review draft schedule
   Vote to change task start dates or durations
Reward agents
   Calculate scores
   Post scores

Revise products and plan (Step 7): Re-plan
Setup: Identification of a situation that necessitates a modification in the plan that has been triggered by changes in problematic situation
End: Modified time-phased schedule of tasks

Objectives:
Identify changes in the problematic situation
   Select the steps that need to be revisited
   Update the description of the situation context
Assemble participants
   Send invitations
   Send updated context description
   Offer incentives
Confirm the steps that need to be revisited
   Vote on the changes that must be made to products
Revisit selected steps
   Answer trigger questions
   Eliminate duplicate answers
   Clarify answers in dialogues
   Summarize dialogues
   Vote to select subset to take forward
Identify relationships
   Answer dependency question comparing two answers
   Conduct mental simulations
   Dialogue about answer rationale
   Provide background material to support rationale
   Cull duplicates entries from dialogues
   Summarize dialogues
   Archive dialogues and summaries
   Compare remaining answers
Display relationships
   Review graphical representation of relationships
   Edit the displays
   Annotate the displays
   Archive the displays
Update plan
   Vote to add or remove actions
   Structure actions
   Review schedule
   Vote to modify tasks
   Vote to revise task start times
   Vote to revise task durations
Reward agents
   Calculate scores
   Post scores

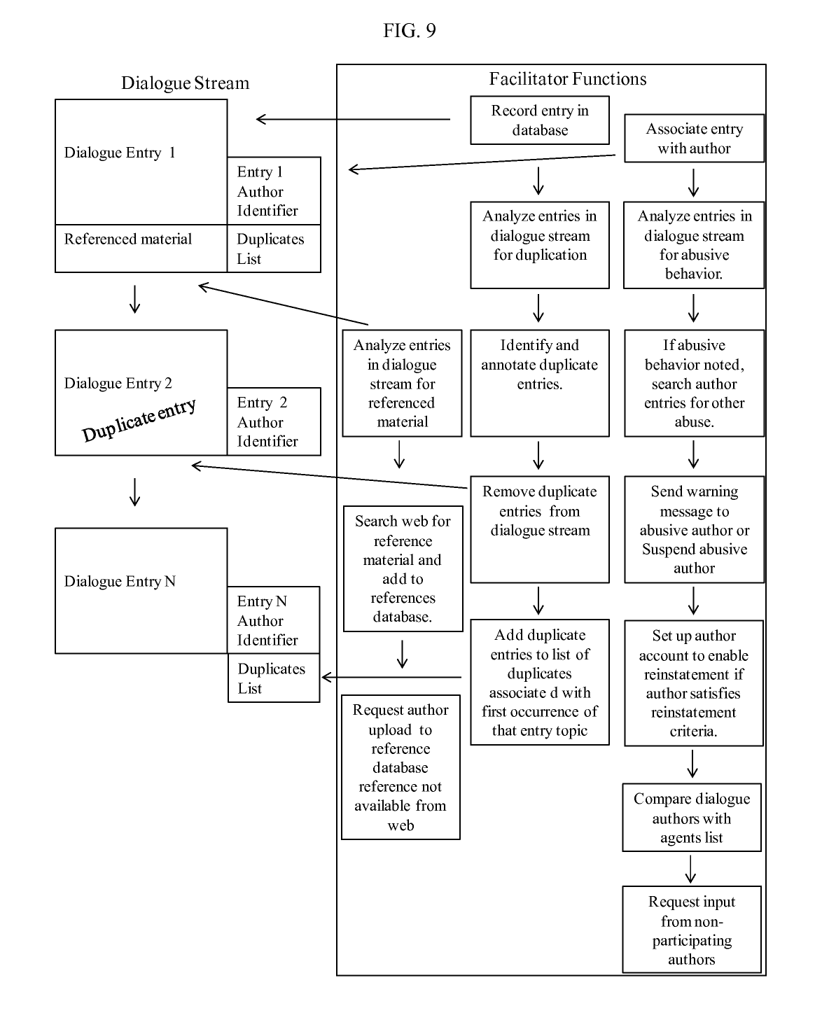

Progress through the steps is facilitated by a combination of MDPSA prompts and participating agent selections as shown in FIG. 9. Facilitation is implemented as described by Warfield, Christakis, Delbecq, Van de Ven and Gustafson, and Pergamit and Peterson. Facilitation is comprised of set-up facilitation and process facilitation. In one embodiment, initiation of an instance is accomplished by means of a wizard which uses a recipe-like guide to set up of the problem-solving process. The products of the recipe are descriptions of the context of a problematic situation and the constraints which influence execution of a problem-solving process. In one embodiment, initiation of the re-planning process is accomplished with a wizard. The re-planning wizard proceeds summarily through the first six steps of the process allowing an agent re-starting an instance to assess the steps which need to be revisited.

Process facilitation leads agents through the seven-step process. In one embodiment, process facilitation is accomplished by means of pre-planned questions which agents answer as the process proceeds. In one embodiment, a group of pre-planned questions is presented to agents. Agents select from the presented questions by vote, and answer the selected questions as the process proceeds. In one embodiment, agents submit questions that specifically address the situation being considered. The MDPSA performs form and function analyses on the submitted questions to verify that they are stated in a form that supports process implementation. Verified questions submitted by agents are added to a list of pre-planned questions; these questions are included in subsequent instances.

In one embodiment, agents are provided with private, personal workspaces as shown in FIG. 4 and FIG. 5. Personal workspaces are used to protect and foster individual decision making processes such as idea generation and thought experimentation. Personal workspaces are accessible only to the participating agent, and cannot be viewed by others while individual decision making is taking place. Personal workspace content is archived with other instance materials when an individual decision-making activity has concluded. Group work spaces are provided for collaborative, problem-solving activities.

In one embodiment, computational linguistic and graphics-processing algorithms are trained on background materials provided by agents and discovered by MDPSA search functions. The training creates an instance-specific catalog of relevant metadata that are characteristic of the problematic situation. Trained algorithms are used to analyze agent inputs to identify and cull redundant inputs from a forum as shown in FIG. 9. Algorithms are further trained by analyzing agent inputs to the problem solving process. While sifting agent inputs, catalog attributes are identified and additional attributes are catalogued. In one embodiment, the catalog is used to identify information contained in agent inputs that is applicable to a particular child dialogue as specified by agents or by computational analyses. The identified, relevant input is inserted into the specified child dialogue as though it was contributed by a participating agent. The applicable information becomes part of the dialogue into which it was inserted, and is subject to subsequent agent discussion and selection.

In one embodiment, computational linguistics and graphics-processing algorithms generate summaries of dialogues. Summary dialogues are continually updated and continuously available to support problem solving. Complete dialogues are stored in an archive for use when detailed review or processing of agent inputs is necessary.

In one embodiment metadata provided by agents and discovered by natural language and graphics processing algorithms are coupled with instance background material. Background material is stored in an archive and is indexed by metadata that enable retrievable and use by human and machine agents. Human-agent indexing enables associative cognitive processes to be applied to background material. In one particular embodiment, background material is brought to the attention of agents in dialogues by aligning metadata extracted from dialogues with metadata extracted from a background item. Machine-agent indexing includes file attributes and processing attributes that enable machines agents to download, open, and process archive items. In one particular embodiment, metadata includes agent appraisals of reference items. In one embodiment, the MDPSA appraisals indicative of the influence an information artifact has had on agents, on individual dialogues, and on the whole instance are included among metadata associated with background material. Influence is indicated by the number of agents accessing the item, the total number of times an item was accessed, the number of child dialogues in which the item was mentioned, or the number of parent dialogues in which the item was mentioned.

In one embodiment, metadata extracted from agent-provided background material are used to identify relevant information throughout the network as part of a search. Computational processing eliminates duplicates and extracts metadata from the background material's source. In one embodiment, networked information is copied and included in the instance archive. In one embodiment, networked information is incorporated into the archive by reference, and is appended with metadata.

In one embodiment, an instance archive stores a complete set of instance artifacts including culled duplicate entries. The instance archive is organized such that an entire instance or individual parts can be retrieved for subsequent modification or can be cloned for alternate use. Child forum dialogues that address problems and solutions are discretely archived in order that materials related to constituent dimensions of an instance can be retrieved and reused in other instances. In one particular embodiment, the MDPSA analyzes an active instance, and recommends historic, archived dimensional dialogues for inclusion in the extant problem-solving process. In one embodiment, archived materials are appended with the names of other instances into which they have been incorporated. This provides heritage traceability, and enables agents to ascertain relationships between complex problems.

In one embodiment, when approaches have been clarified, a sufficiency check is performed to determine that enough knowledge has been generated to proceed with approach selection as shown in FIG. 3. If it is determined that more information is required, the problems and relationships are revisited and additional questions are posed to trigger the generation of additional knowledge.

In one embodiment, when actions have been clarified, a sufficiency check is performed to determine that enough knowledge has been generated to proceed with plan generation as shown in FIG. 3. If it is determined that more information is required, the solutions and relationships are revisited and additional questions are posed to trigger the generation of additional knowledge.

In one particular embodiment, the steps are represented as game levels each level having its own objective.

In one embodiment, the rewards agents receive are numerical scores that are incremented for constructive contributions and behaviors and are decremented for destructive contributions and behaviors. In one particular embodiment, agents received scores for their expertise, for their performance in the extant instance, and for their performance across all instances in which they have participated.

Scoring can be approached in a variety of ways. In one embodiment, scoring is linked to contribution statistics, qualitative attributes of interpersonal interactions, contribution effectiveness, argument errors and fallacious reasoning, and peer assessments.

Extremes in socially dysfunctional behavior such as internet flaming, ad hominem attacks, and aggressive profanity can undermine a problem solving instance and must be kept in check. In one embodiment, agents exhibiting dysfunctional behaviors can be brought up for trial by other agents, and can be removed from the instance by referendum. In one embodiment, a dysfunctional agent is autonomously identified and removed from the instance.

Massively distributed collaboration must be perceived as fair by participating agents. Summary removal from an instance may undermine agent trust if it is perceived to be haphazard, biased, or inadvertent. A procedure for reinstatement of agents provides a guard against the erosion of perceived fairness. Reinstatement can be approached in a variety of ways. In one embodiment, a process of apology, explanatory statement, and peer voting is implemented to allow an agent to be reinstated. In another embodiment, administrators review agent behavior and decide whether to reinstate the agent.

In one particular embodiment, agents scores are used to align agents with new instances, potential employers or customers. Players with high scores are autonomously recommended for participation in an extant instance based on an identified need for expertise in the instance. In one embodiment, instance stakeholders review ranked scores by expertise and chose to extend invitations to high-scoring agents. Invitations may be extended using embedded invitation functionality with and without offers of compensation or other incentives for participation. In one embodiment, agents use their scores to search for networked employment postings or other work opportunities that align with their expertise. Prospective employers and customers review agent scoring, and use it as evidence of qualification for an advertised need.

Having described the invention in detail and by reference to specific embodiments thereof, it will be apparent that numerous variations and modifications are possible without departing from the spirit and scope of the invention.

What is claimed is:

1. A knowledge processing system that enables massive numbers of human agents and artificial intelligence agents to define, explore, and develop a solution for a problematic situation, where massive is bounded by the number of agents on the internet worldwide, comprising: an electromagnetic communications network; client devices that enable human and artificial intelligence agents to supply inputs to the knowledge processing system and receive outputs from the knowledge processing system over said network; said client devices configurable to provide private workspaces for agents from which other agents are precluded and public workspaces in which agents jointly work; an information storage and access system for managing knowledge processing system outputs and agent inputs; a facilitation system configured to guide agents through the exercise of problem-solving steps; said steps are problem definition, identification of the topical information domains of which the problematic situation is comprised, exploration of the problematic situation, definition of solution approaches, selection of a solution approach from those defined by agents, description of the solution approaches, and time-sequenced action plan creation; said facilitation system presents to agents for selection as solution approaches technological, investment, engineering, data mining, experiment, information campaigning, organizational change, regulatory change, research, additional expertise, statutory change, education, marketing, quality improvement, and visioning approaches; said problem-solving exercise is comprised of parent forums in which the problematic situation is considered as a whole and child forums in which the problematic situation is considered in parts as described by agent-identified, topical-information domains; said facilitation system decomposes the problematic-situation exploration step and the solution-definition step into child forums, one child forum for each topical-information domain of which the problematic situation is comprised; said facilitation system guides agents in the synthesis and relation of problematic-situation exploration child forum findings into a holistic representation of the problematic situation; said facilitation system guides agents in the synthesis and relation of solution-defining, child-forum findings into an integrated solution comprised of solutions that address sub problems of the problematic situation that are peculiar to topical-information domains; said facilitation system automatically assigns agents to participate in child forums based on self-identified expertise and interests elicited from agents by the system; said facilitation system transmits input prompts to agents; some of said input prompts direct agents to provide a description of the problematic situation; some of said input prompts direct agents to provide a description the temporal and financial constraints and goals of the problem-solving situation; some of said input prompts direct agents to select questions from a list of questions maintained in said data storage system; some of said input prompts direct agents to submit answers to questions; some of said input prompts direct agents to clarify answers in a dialogue format; some of said input prompts direct agents to select answers from among those submitted by agents; some of said prompts direct agents to preferentially rank answers; said data storage system configured to associate agent responses with system-generated prompts; said data storage system configured to store agent responses to prompts; said storage and access system aggregating system outputs and agent inputs so they can be reused in whole or in part by other implementations of the system for other problematic situations; said facilitation system enforces agent-defined, time constraints of the problem-solving exercise.

2. The system in claim 1, wherein knowledge processing tasks are knowledge generation, knowledge clarification, knowledge selection, knowledge structuring, knowledge refinement, information collection, dialoguing, polling, analogy development, mental simulation exercises, and storytelling.

3. The system in claim 1, wherein agents are prompted to perform cognitive simulations of outcomes achieved using an approach and engage in dialogues to probe the strengths and weakness of the approach in resolving the problematic situation;

4. The system in claim 1, wherein agents contribute background or reference materials in the form of textual, audio or visual materials that are related to the problematic situation to the data storage and access system both as a precursor to a step in the problem-solving exercise and in the course of exchanging ideas in dialogue with other agents.

5. The system in claim 1, wherein the exercise of problem-solving steps includes a feedback step in which agents are prompted to revisit one or more of the preceding problem-solving steps in order to modify the outputs in response to a change in the problematic situation.

6. The system in claim 1, wherein agents receive rewards commensurate with the quality and quantity of their contributions to the problem-solving exercise and are assessed penalties for contributions that detract from the problem-solving exercise, wherein penalties can extend to an agent suspension from further participation, requiring the agent to undergo a reinstatement process to resume participation.

7. The system in claim 6, wherein the knowledge processing system is configured as a multi-level game with the problem-solving steps serving as game levels and the rewards and penalties are tallied by the facilitation system and presented in the form of game scores wherein agents receive scores for excellence in the present exercise, for excellence in all exercises of the system in which they have participated, and for their expertise in a particular domain.

8. The system in claim 7, wherein agent scores are made available to employers as part of an employment process external to but interfacing with the present invention in which the agent scores are used as indicators of agent skills, knowledge, expertise and qualification.

9. A hybrid facilitation system in which human agents and artificial intelligence agents collaboratively facilitate the actions of a knowledge processing system, comprising: a knowledge processing system in which agent-submitted questions are stored by the system; said knowledge processing system employs agent-submitted questions to guide a problem solving exercise; said knowledge processing system incorporates agent-submitted questions into the knowledge processing system baseline for use in future problem solving instances; the order of knowledge processing steps is agent-defined by means of a polling process, to fit the temporal and financial constraints of a problem-solving activity; knowledge processing tasks comprised of knowledge generation, knowledge clarification, knowledge selection, knowledge structuring, knowledge refinement, information collection, dialoguing, polling, analogy development, mental simulation exercises, and storytelling tasks are presented to agents as process building blocks; said building blocks and the order in which the building blocks are used are selected by agents through a polling process.

10. The system in claim 9, wherein the system semantically critiques agent-generated questions and provides an assessment of sufficiency and effectiveness, and provides guidance on improving agent-generated questions when the system determines a superior version can be achieved.

11. The system in claim 9, wherein the system prompts agents to submit answers to questions and the knowledge processing system determines sequential dependencies between and among the agent-submitted answers and presents the dependencies in a graphical, hierarchical display.

12. The system in claim 11, wherein the system prompts agents to review and revise the sequential dependencies determined by the knowledge processing system by presenting pairwise comparisons of agent answers and prompting agents to determine relationships between answers by means of participant polling.

13. The system in claim 9, wherein the system guides agents to decompose the problematic situation into constituent parts, the system assigns agents the constituent parts in which they will participate, and agents self-select and de-select the constituent parts of the problematic situation in which they will participate.

14. An information-overload mitigation system which reduces the information processed by human agents and artificial intelligence agents interacting with and within a network-based, internet-scale problem solving system to a level which requisite parsimony constraints are satisfied without sacrificing the requisite variety necessary for complex-problem solution, comprising: an information storage and retrieval system in which agent inputs are managed; natural language processing algorithms; said natural language processing algorithms extract key words, proper names, phases, activities, shapes, symbols, meaning, intent, context and affective content attributes from agent inputs; said natural language processing algorithms performing pairwise, semantic comparisons between textual and audio agent inputs and identifying, tagging, sequestering, and eliminating inputs with identical content from agent inputs to the problem solving system; said natural language processing continually summarizing the aggregate content of agent inputs and presenting the summary to agents; graphics processing algorithms; said graphics processing algorithms performing pairwise comparisons between graphical and video agent inputs and identifying, tagging, sequestering, and eliminating inputs with identical content from agent inputs to the problem solving system.

15. The system in claim 14, wherein the natural language processing algorithms are trained on agent-supplied background materials maintained in said information storage and access system.

16. The system in claim 14, wherein knowledge stored in the information management system is tagged with metadata terms that are displayed so that agents can select from said terms in order to request tagged knowledge with the selected metadata be incorporated into the problem-solving process at agent-selected points of application.

17. The system in claim 16, wherein agents contribute rankings of the usefulness of individual items in said information management system to the metadata associated with the individual items for the purpose of focusing agent attention on the most useful data items.

18. The system in claim 14, wherein the system uses content attributes extracted by natural processing algorithms to determine points of application within the said problem solving system for a stored information item and directs the information to that point of application by reference or by full display of the information item at the point of application.

19. The system in claim 14, wherein metadata identified by said natural language processing algorithms and common features identified by said graphical processing algorithms are used as search terms in semantic searches of content available over said network for the purpose of referencing material related to the problem solving processing or for retrieving the material for storage in said information management system.

20. The system in claim 19, wherein the system creates a network display of material identified by means of semantic search that depicts network relationships by location between the search-discovered information items.
